(19) United States
(12) Patent Application Publication
(10) Pub. No.: US 2019/0359853 A1
(43) Pub. Date: Nov. 28, 2019

(54) SHEAR THICKENING MATERIALS AS LIGHTWEIGHT SURFACE ARMOR

(71) Applicant: GM GLOBAL TECHNOLOGY OPERATIONS LLC, Detroit, MI (US)

(72) Inventors: Qiangfeng XIAO, Troy, MI (US); Ming YANG, Novi, MI (US); Neeraj S. SHIDORE, Novi, MI (US); Jingyan WAN, Sterling Heights, MI (US); Wen-Chiao LIN, Rochester Hills, MI (US); Jian YAO, Shanghai (CN)

(73) Assignee: GM GLOBAL TECHNOLOGY OPERATIONS LLC, Detroit, MI (US)

(21) Appl. No.: 15/988,594

(22) Filed: May 24, 2018

(51) Int. Cl. C09D 183/08; C08J 3/24

(52) U.S. Cl. CPC C09D 183/08; C08J 3/24

(57) ABSTRACT

A shear thickening composition is provided. The shear thickening composition includes polydimethylsiloxane (PDMS) and boron. The boron is cross-linked to an oxygen atom in the PDMS to yield boron-cross-linked PDMS (B-PDMS). Vehicle parts including the shear thickening composition and methods of coating vehicle parts with the thickening composition are also provided.

### INTRODUCTION

This section provides background information related to the present disclosure which is not necessarily prior art.

Vehicle bodies desirably manage the loads applied during both normal service conditions, as well as under extraordinary conditions, such as a collision or during exposure to other excessive forces or impact. Increasingly, vehicle bodies are constructed using materials such as polymer-based composites that offer higher strength to weight ratios than low carbon steel used in some other designs. Polymeric composites in particular are useful in automobiles and their utilization is expected to continue increasing in the future in an effort to further reduce the vehicle mass. However, polymeric composites may not prevent cracks or dents resulting from collisions.

Automobile parts such as structural panels, truck beds, and bumpers made from polymer composites are preferably designed to resist damage from low speed collisions, impacts from small stones or objects, the weight of a leaning person, weather, e.g., hail, and the addition of loads (such as with a truck bed). Nonetheless, scuffs, dents, cracks, and other defects or damage often result from collisions. Given certain part shapes, dimensions, or the assembly technologies, it is sometimes easier to replace a component than repair it. Accordingly, there remains a need for improved vehicle panels that can protect against cracks and dents caused by various impacts.

### SUMMARY

This section provides a general summary of the disclosure, and is not a comprehensive disclosure of its full scope or all of its features.

In various aspects, the current technology provides a shear thickening composition including polydimethylsiloxane (PDMS) and boron, wherein the boron is cross-linked to an oxygen atom in the PDMS to yield boron-cross-linked PDMS (B-PDMS).

In one aspect, the B-PDMS includes molecules having at least one of formula (I) and formula (II):

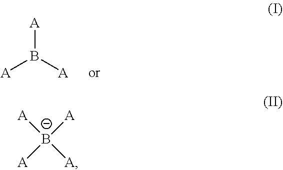

where at least one A is:

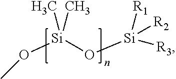

where R₁, R₂, and R₃ are individually H, OH, methyl, ethyl, phenyl, vinyl, methoxy, or ethoxy, and n is an integer greater than or equal to 0, and each remaining A is —OH.

In one aspect, the composition has the structure:

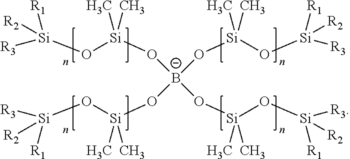

In one aspect, the B-PDMS is a bridged molecule wherein at least one methyl group (CH₃) of a first molecule having formula (I) or formula (II) is cross-linked to a second methyl group of a second molecule having formula (I) or formula (II), such that the first molecule and the second molecule are coupled together by a —CH₂-CH₂— bridge.

In one aspect, the composition further includes an inorganic filler.

In one aspect, the inorganic filler is a glass bubble, a silica nanoparticle, a carbon fiber, suspensions thereof, and combinations thereof.

In one aspect, the inorganic filler is a suspension including the inorganic filler and polyethylene glycol.

In one aspect, the composition is a solid and is configured to be applied to a surface by melting.

In various aspects, the current technology also provides a vehicle part including a body pane and a layer of a shear thickening composition coated onto the body panel, wherein the shear thickening composition includes boron-cross-linked PDMS (B-PDMS).

In one aspect, the B-PDMS includes molecules having at least one of formula (I) and formula (II):

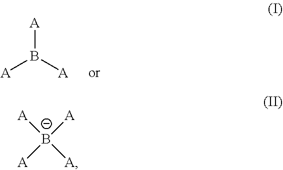

where at least one A is:

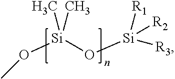

where R₁, R₂, and R₃ are individually H, OH, methyl, ethyl, phenyl, vinyl, methoxy, or ethoxy, and n is an integer greater than or equal to 0; and each remaining A is —OH.

In one aspect, the B-PDMS is a bridged structure including a first B-PDMS molecule coupled to a second B-PDMS molecule by way of a —CH₂-CH₂— bridge.

In one aspect, the shear thickening composition further includes an inorganic filler selected from the group including a glass bubble, a silica nanoparticle, a carbon fiber, a polyethylene glycol suspension thereof, and a combination thereof.

In one aspect, the body panel includes steel, aluminum, a polymer, or a polymer composite.

In one aspect, the layer has a thickness of greater than or equal to about 1 μm to less than or equal to about 10 mm.

In one aspect, the vehicle part dissipates impact energy greater than a second vehicle part having a second panel that is the same as the body panel, but which does not include a layer of the shear thickening composition.

In various aspects, the current technology further provides a method of preparing a body panel for a vehicle, the method including disposing a solid shear thickening composition onto an exterior surface of the body panel, the solid shear thickening composition including boron-cross-linked PDMS (B-PDMS); melting the solid shear thickening composition to generate a layer of uncured shear thickening composition on the body panel; and curing the uncured shear thickening composition to generate a coating of the shear thickening composition on the body panel.

In one aspect, the solid shear thickening composition further includes at least one of a bridged structure having a first B-PDMS molecule coupled to a second B-PDMS molecule by way of a —CH₂-CH₂— bridge, and an inorganic filler selected from the group including a glass bubble, a silica nanoparticle, a carbon fiber, a polyethylene glycol suspension thereof, and a combination thereof.

In one aspect, the vehicle is an automobile.

In one aspect, the method further includes, prior to the curing, spreading the uncured shear thickening composition on the body panel to generate an even layer of the uncured shear thickening composition on the body panel.

In one aspect, the curing includes incubating the uncured shear thickening composition on the body panel at room temperature until the coating is formed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a shear thickening composition in accordance with various aspects of the current technology.

FIG. 2 is a graph of load versus extension for a shear thickening composition in accordance with various aspects of the current technology.

FIG. 3 is a schematic illustration of cross-linking in a shear thickening composition in accordance with various aspects of the current technology.

FIG. 4 is a scheme for bridging shear thickening composition molecules together in accordance with various aspects of the current technology.

FIG. 5 is a scheme for adding an inorganic filler to a shear thickening composition in accordance with various aspects of the current technology.

FIGS. 6A-6C show graphic illustrations of a panel having a shear thickening composition coating and being subjected to an impact force in accordance with various aspects of the current technology.

FIGS. 7A-7C show an example of an uncoated panel, a panel coated with rubber, and a panel coated with a shear thickening composition in accordance with various aspects of the current technology. Surface protection results of the panels after impact testing are also shown.

FIGS. 8A-8B show an example of an uncoated panel and a panel coated with a shear thickening composition in accordance with various aspects of the current technology. Surface protection results of the panels after impact testing are also shown.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology provides a shear thickening composition. The shear thickening composition can be applied to vehicle body panels and dissipates impact energy to mitigate or prevent the body panels from developing cracks and dents as a result of an impact. Impact-induced stiffening helps maintain an original shape of a coating layer comprising the shear thickening composition and the original shape recovers through a self-healing process after removal of an impact. Therefore, even though impacts can cause scuffs, dents, cracks, and other defects to vehicle body panels, the shear thickening composition, when applied to a surface of the body panels, smartly protects the surfaces of the body panels by an adaptive response to external impacts.

The shear thickening composition comprises polydimethylsiloxane (PDMS) and boron. The boron is cross-linked to an oxygen atom in the PDMS to yield boron-cross-linked PDMS (B-PDMS). The B-PDMS comprises molecules having at least one of formula (I) or formula (II):

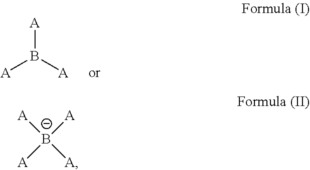

where at least one A is

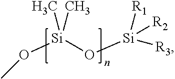

where R₁, R₂, and R₃ are individually H, OH, methyl, ethyl, phenyl, vinyl, methoxy, or ethoxy, and n is an integer greater than or equal to 0; and each remaining A, if any, is —OH.

In various embodiments, the B-PDMS has the structure:

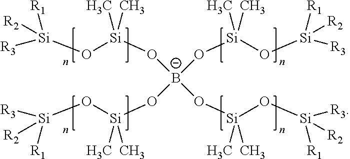

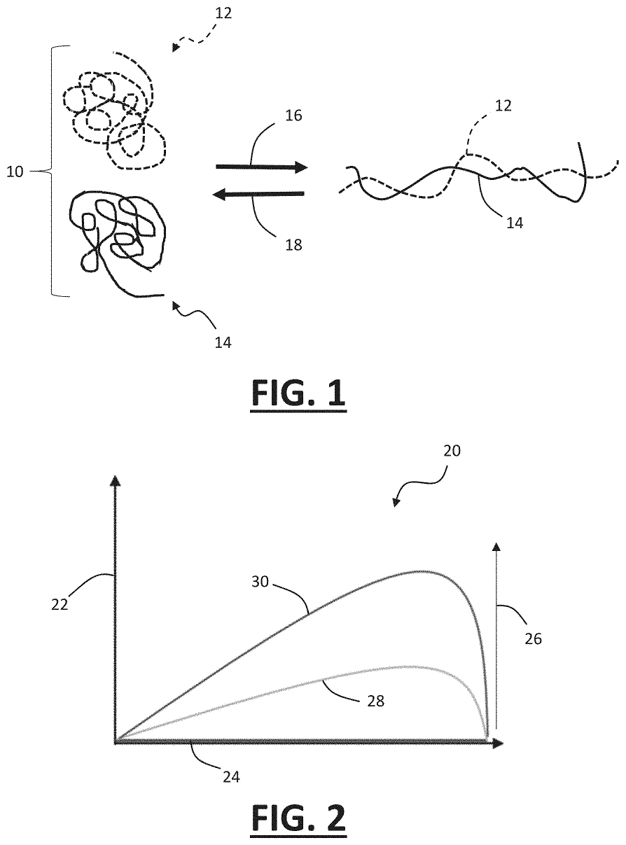

When applied to an external surface of a vehicle panel, the B-PDMS absorbs impact energy. In a shear thickening composition that does not have a force acting on it, the B-PDMS is present as random coils. For example, FIG. 1 shows a shear thickening composition 10 comprising a first B-PDMS molecule 12 and a second B-PDMS molecule 14 in a first configuration comprising separated random coils. No force is acting on the shear thickening composition 10 and it has a first viscosity. When a force, such as load, stress, or shear as non-limiting examples, is applied to the shear thickening composition 10, as represented by a first arrow 16, the first and second B-PDMS molecules 12, 14 unwind and adapt a second configuration in which the first and second B-PDMS molecules 12, 14 are entangled with each other. The shear thickening composition 10 in the second configuration has a second viscosity, wherein the second viscosity is higher than the first viscosity. By adopting this second configuration, the shear thickening composition 10 absorbs energy provided by the force. When force is removed, as represented by a second arrow 18, the first and second B-PDMS molecules 12, 14 return to the first configuration, i.e., separated random coils. This mechanism enables the shear thickening composition to have self-healing properties.

The B-PDMS is generated, for example, by mixing PDMS with boric acid at a PDMS:boric acid mass ratio of 20:1 at 500 under mechanical stirring at 500 rpm. The resulting mixture is heated to about 200° C. for about 30 minutes and reacted for 6 hours. After cooling to room temperature, B-PDMS is obtained.

Energy, i.e., impact energy, absorbed by the shear thickening composition can be described with reference to a graph. For example, FIG. 2 shows a graph 20 with a y-axis 22 representing load (or stress) and an x-axis 24 representing extension (or strain). An upward facing arrow 26 represents impact. The graph 20 is particular to the shear thickening composition. As a first load is applied to the shear thickening material, the shear thickening material extends and a first curve 28 is generated. An area under the first curve represents energy absorbed by the shear thickening composition. As a second load is applied to the shear thickening composition, the second load being larger than the first load, the shear thickening material extends and a second curve 30 is generated. As can be seen by the curves 28, 30, the larger the load, the more energy that is absorbed by the shear thickening composition. When a load (or stress) is below an elastic limit of a material, then no damage will occur to the material. Rather, the material will deform and then return to its original shape. However, if a load (or stress) is greater than the elastic limit of the material, then the material will be damaged, such as, for example, with a crack or dent.

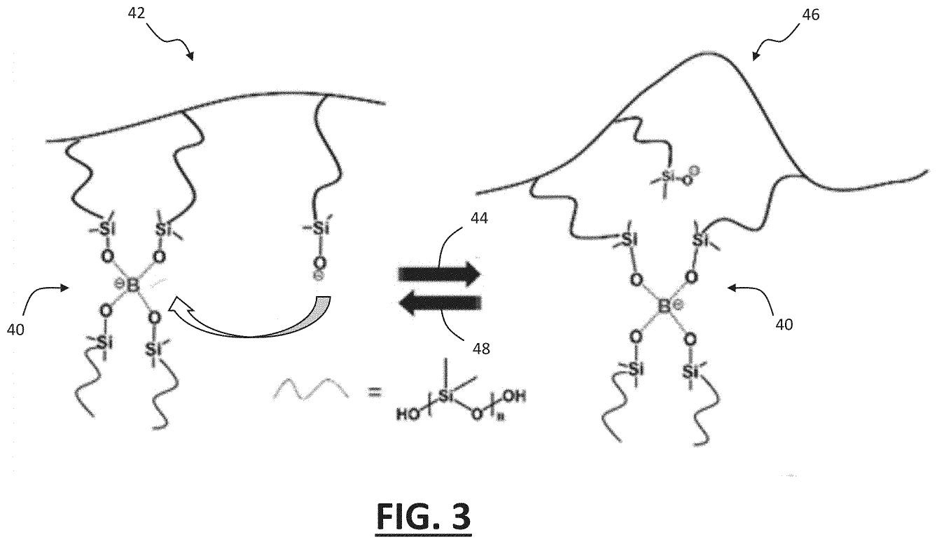

FIG. 3 shows B-PDMS molecules of a shear thickening composition 40 comprising B-PDMS in a first configuration 42. Here, a boron (B) atom is cross-linked between several original PDMS molecules. As a force is applied to the shear thickening composition 40, as represented by a first arrow 44, the shear thickening composition 40 is rearranged such that the B atom becomes located nearer to other PDMS molecules. As a result, a new cross-link is formed between one of the other PDMS molecules and the boron atom and the shear thickening composition 40 arranges into a second configuration 46. As the force is removed, as represented by a second arrow 48, the shear thickening composition 40 relaxes, which causes the B atom to be pulled away from the one of the other PDMS molecules, and rearranges back into the first configuration 42. This mechanism also enables the shear thickening composition to have self-healing properties.

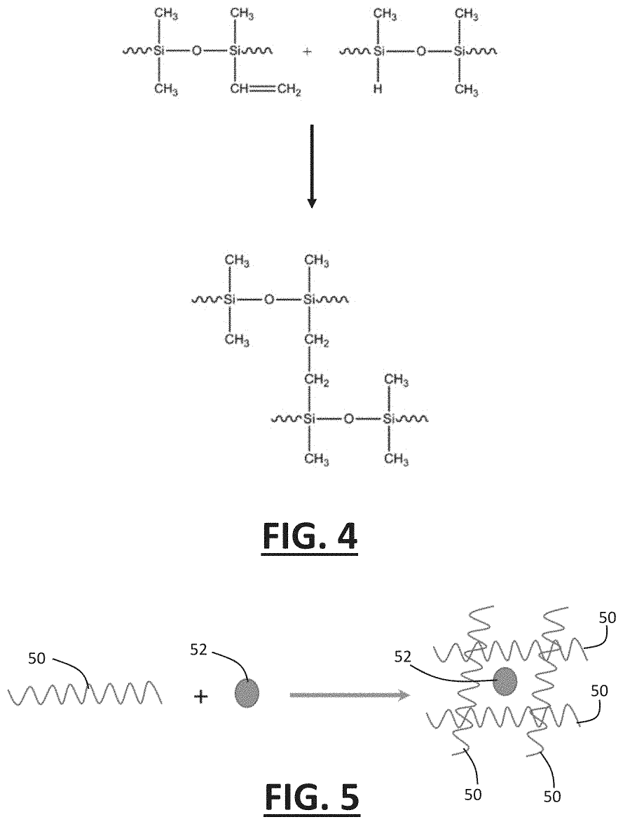

The shear thickening composition of the current technology is tunable so that it can withstand a greater amount of impact force. For example, with reference to FIG. 4, the shear thickening composition is tuned by generating a bridged structure comprising a first B-PDMS molecule coupled to a second B-PDMS molecule (or to a PDMS molecule) by way of a —CH₂-CH₂— bridge. As a result, the B-PDMS is a bridged molecule, wherein at least one methyl group (CH₃) of a first molecule having formula (I) or formula (II) is cross-linked to a second methyl group of a second molecule having formula (I) or formula (II) or to a PDMS molecule, such that the first molecule and the second molecule are coupled together by a —CH₂-CH₂— bridge.

Generating the bridged structure is performed by introducing an ethenyl (vinyl) containing silane (for example, vinyldimethylethoxysilane) on a first B-PDMS molecule, through a hydrolysis reaction with residual —OH groups in B-PDMS. The first B-PDMS molecule is then contacted with one of a second B-PDMS molecule or a PDMS molecule in the presence of a platinum (Pt) catalyst and heat at 40° C. overnight. Generating bridges in this manner tunes or adjusts the amount of impact energy the shear thickening composition can absorb.

The shear thickening composition can also be tuned or adjusted by adding an inorganic filler to the shear thickening composition. For example, FIG. 5 shows a B-PDMS backbone 50 and an inorganic filler 52. The inorganic filler 52 is a glass bubble (i.e., small hollow glass beads), a silica nanoparticle, a carbon fiber, a polyethylene glycol suspension thereof, or a combination thereof. The inorganic filler 52 can be included at a concentration of greater than or equal to about 1 wt. % to less than or equal to about 50 wt. %.

The shear thickening composition can be provided as a solid that is configured to be applied to a surface by melting.

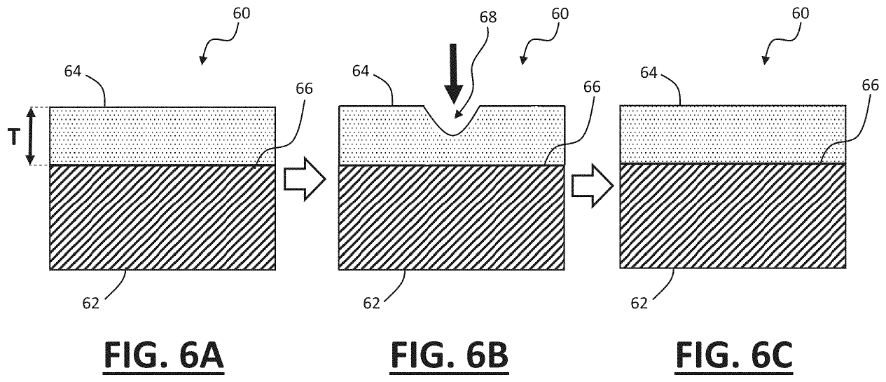

With reference to FIG. 6A, the current technology also provides a vehicle part 60. The vehicle part comprises a body panel 62 and a layer of shear thickening composition 64 coated onto the body panel 62. More particularly, the layer of shear thickening composition 64 is disposed on an exposed surface 66 of the body panel 62, where an “exposed surface” is a surface that can be seen by an individual. The layer of shear thickening composition 64 has a thickness T of greater than or equal to about 1 μm to less than or equal to about 10 mm, greater than or equal to about 100 μm to less than or equal to about 8 mm, of greater than or equal to about 500 μm to less than or equal to about 5 mm. The layer of shear thickening composition 64 comprises B-PDMS (tunable), as described above.

The body panel 62 can be a part of any vehicle, such as a bicycle, an automobile, a motorcycle, a boat, a personal water craft, a submarine, a tractor, an all-terrain vehicle, a bus, a mobile home, a camper, a glider, an airplane, or a military vehicle, such as a tank. In various embodiments, the body panel 62 comprises steel, aluminum, a polymer, or a polymer composite.

In FIG. 6B, the vehicle part 60 is being impacted by an object, which may be, for example, another vehicle, a person, a weather artifact (e.g., hail), or any other object that can damage a vehicle's body panel. The force of the impact is shown by the solid black block arrow. As can be seen in FIG. 6B, the layer of shear thickening composition 64 forms a deformity 68 as it absorbs energy from the impact, i.e., impact energy, as described above. As shown in FIG. 6C, when the force is removed, the deformity 68 disappears as the layer of shear thickening composition 64 returns to its original condition. Accordingly, the vehicle part 60 dissipates impact energy greater than a second vehicle part comprising a second panel that is the same as the body panel 62, but which does not comprise a layer of the shear thickening composition.

The current technology also provides a method of preparing a body panel for a vehicle. The method comprises disposing a solid shear thickening composition onto an exterior surface of the body panel. The solid shear thickening composition comprises B-PDMS, which is described above. The method further comprises melting the shear thickening composition to generate a layer of uncured shear thickening composition on the body panel. Melting can be performed, for example, in an oven or furnace. In various embodiments, the melting comprises heating the body panel and solid shear thickening composition to a temperature above the melting temperature of the solid shear thickening composition, such as a temperature of greater than or equal to about 50° C. to less than or equal to about 300° C. or greater than or equal to about 100° C. to less than or equal to about 200° C. The heating is performed for a time period sufficient to melt the entire solid shear thickening composition, such as a time of greater than or equal to about 5 minutes to less than or equal to about 5 hours, greater than or equal to about 15 minutes to less than or equal to about 4 hours, or greater than or equal to about 30 minutes to less than or equal to about 3 hours.

In some embodiments, the method also includes spreading the uncured shear thickening composition on the body panel to generate an even layer of the uncured shear thickening composition on the body panel. The spreading can be performed with a brush, wipe, doctor blade, or air, as non-limiting examples.

After the melting (and the optional spreading), the method comprises curing the uncured shear thickening composition to generate a coating of the shear thickening composition on the body panel. The curing comprises incubating the uncured shear thickening composition on the body panel at a temperature below the melting temperature of the shear thickening composition, such as, for example, at room temperature or cooler, until the coating is solidified and formed.

Embodiments of the present technology are further illustrated through the following non-limiting examples.

### Example 1

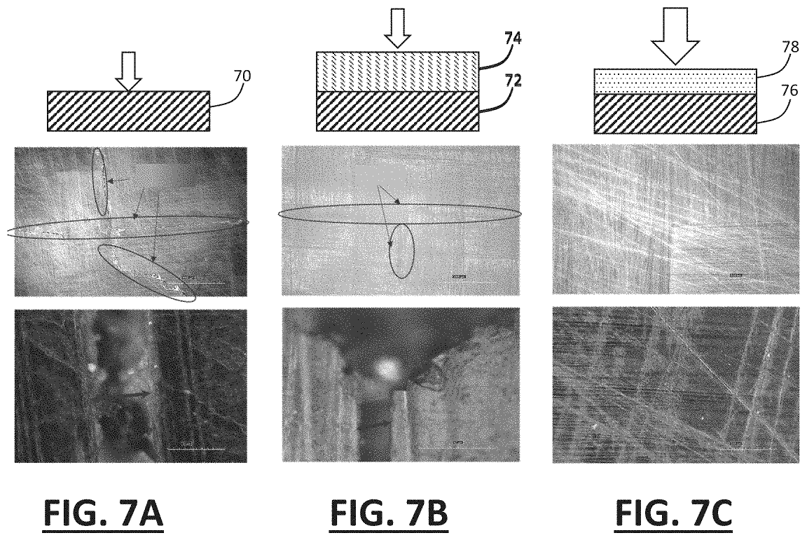

With reference to FIGS. 7A-7C, various surfaces are prepared for surface impact testing. FIG. 7A shows a pristine first carbon fiber panel 70 without a coating. FIG. 7B shows a second carbon fiber panel 72 comprising a coating of a rubber composition 74. FIG. 7C shows a third carbon fiber panel 76 comprising a coating of a shear thickening composition 78 according to the current technology. The coating of the shear thickening composition 78 has a thickness that is one half the thickness of the rubber composition 74 on the second carbon fiber panel 72. Standard impact testing is conducted. The first and second carbon fiber panels 70, 72 are subjected to the same impact force, and the third carbon fiber panel 76 is subjected to an impact force that is larger than the impact force applied to the first and second carbon fiber panels 70, 72. Impact forces are represented by block arrows.

Results of the standard impact tests are shown in the photographs, with the lower photographs having a larger magnification than the upper photographs. In FIG. 7A, the pristine first carbon fiber panel 70 without a coating develops cracks with widths of about 50 μm (circled in the upper photograph). In FIG. 7B, the second carbon fiber panel 72 coated with the rubber composition 74 develops cracks with widths of about 20 μm. In FIG. 7C, the third carbon fiber panel 76 coated with the coating of the shear thickening composition 78 does not develop cracks. Therefore, of the three carbon fiber panels 70, 72, 76, only the third carbon fiber panel 76 coated with the coating of the shear thickening composition 78 is protected from the impact.

### Example 2

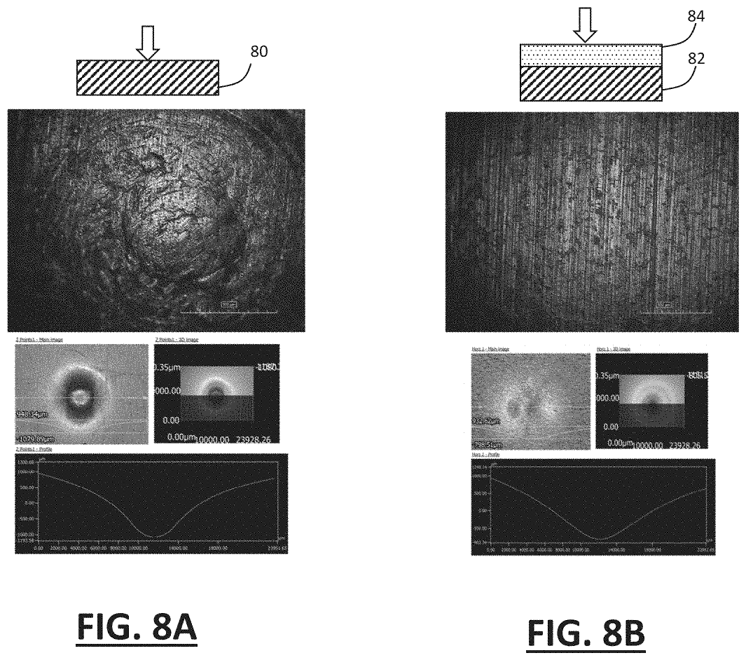

With reference to FIGS. 8A-8B, two surfaces are prepared for surface impact testing. FIG. 8A shows a pristine first aluminum panel 80 without a coating. FIG. 8B shows a second aluminum panel 82 comprising a coating of a shear thickening composition 84 according to the current technology. The first and second aluminum panels 80, 82 are subjected to the same impact force, which is represented by block arrows.

Results of the impact tests are shown in the photographs and graphs. In FIG. 8A, the pristine first aluminum panel 80 plate develops a dent having a depth of 2.03 mm. In FIG. 8B, the second aluminum panel 82 comprising the coating of the shear thickening composition 84 develops a dent having a depth of only 1.73 mm Therefore, the shear thickening composition 84 on the second aluminum panel 82 absorbs impact energy and decreases damage to the second aluminum panel 82 resulting from impact energy relative to the pristine first aluminum panel 80.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shear thickening composition comprising:
polydimethylsiloxane (PDMS); and
boron,
wherein the boron is cross-linked to an oxygen atom in the PDMS to yield boron-cross-linked PDMS (B-PDMS).

2. The composition according to claim 1, wherein the B-PDMS comprises molecules having at least one of formula (I) and formula (II): 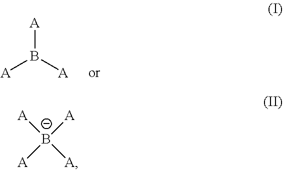
where at least one A is: 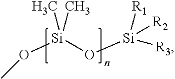
where R₁, R₂, and R₃ are individually H, OH, methyl, ethyl, phenyl, vinyl, methoxy, or ethoxy, and n is an integer greater than or equal to 0; and
each remaining A is —OH.

3. The composition according to claim 2, wherein the composition has the structure:

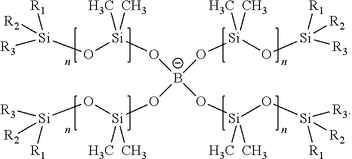

4. The composition according to claim 2, wherein the B-PDMS is a bridged molecule wherein at least one methyl group (CH₃) of a first molecule having formula (I) or formula (II) is cross-linked to a second methyl group of a second molecule having formula (I) or formula (II), such that the first molecule and the second molecule are coupled together by a —CH₂-CH₂— bridge.

5. The composition according to claim 1, further comprising an inorganic filler.

6. The composition according to claim 5, wherein the inorganic filler is a glass bubble, a silica nanoparticle, a carbon fiber, suspensions thereof, and combinations thereof.

7. The composition according to claim 5, wherein the inorganic filler is a suspension comprising the inorganic filler and polyethylene glycol.

8. The composition according to claim 1, wherein the composition is a solid and is configured to be applied to a surface by melting.

9. A vehicle part comprising:
a body panel; and
a layer of a shear thickening composition coated onto the body panel,
wherein the shear thickening composition comprises boron-cross-linked PDMS (B-PDMS).

10. The vehicle part according to claim 9, wherein the B-PDMS comprises molecules having at least one of formula (I) and formula (II): 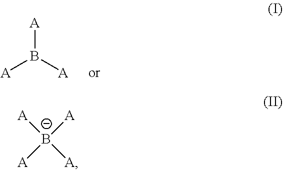
where at least one A is: 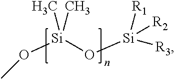
where R₁, R₂, and R₃ are individually H, OH, methyl, ethyl, phenyl, vinyl, methoxy, or ethoxy, and n is an integer greater than or equal to 0; and
each remaining A is —OH.

11. The vehicle part according to claim 9, wherein the B-PDMS is a bridged structure comprising a first B-PDMS molecule coupled to a second B-PDMS molecule by way of a —CH₂-CH₂— bridge.

12. The vehicle part according to claim 9, wherein the shear thickening composition further comprises an inorganic filler selected from the group consisting of a glass bubble, a silica nanoparticle, a carbon fiber, a polyethylene glycol suspension thereof, and a combination thereof.

13. The vehicle part according to claim 9, wherein the body panel comprises steel, aluminum, a polymer, or a polymer composite.

14. The vehicle part according to claim 9, wherein the layer has a thickness of greater than or equal to about 1 μm to less than or equal to about 10 mm.

15. The vehicle part according to claim 9, wherein the vehicle part dissipates impact energy greater than a second vehicle part comprising a second panel that is the same as the body panel, but which does not comprise a layer of the shear thickening composition.

16. A method of preparing a body panel for a vehicle, the method comprising;
disposing a solid shear thickening composition onto an exterior surface of the body panel, the solid shear thickening composition comprising boron-cross-linked PDMS (B-PDMS);
melting the solid shear thickening composition to generate a layer of uncured shear thickening composition on the body panel; and
curing the uncured shear thickening composition to generate a coating of the shear thickening composition on the body panel.

17. The method according to claim 16, wherein the solid shear thickening composition further comprises at least one of:
a bridged structure comprising a first B-PDMS molecule coupled to a second B-PDMS molecule by way of a —CH₂-CH₂— bridge, and
an inorganic filler selected from the group consisting of a glass bubble, a silica nanoparticle, a carbon fiber, a polyethylene glycol suspension thereof, and a combination thereof.

18. The method according to claim 16, wherein the vehicle is an automobile.

19. The method according to claim 16, further comprising, prior to the curing:
spreading the uncured shear thickening composition on the body panel to generate an even layer of the uncured shear thickening composition on the body panel.

20. The method according to claim 16, wherein the curing comprises incubating the uncured shear thickening composition on the body panel at room temperature until the coating is formed.
